(19) United States
(12) Patent Application Publication
(10) Pub. No.: US 2024/0243249 A1
(43) Pub. Date: Jul. 18, 2024

(54) HIGH-PERFORMANCE LITHIUM-ION BATTERY CELL DESIGNS WITH LITHIATED SILICON OXIDE (LSO) ANODES

(71) Applicant: GM GLOBAL TECHNOLOGY OPERATIONS LLC, Detroit, MI (US)

(72) Inventors: Dewen KONG, Shanghai (CN); Meiyuan WU, Shanghai (CN); Haijing LIU, Shanghai (CN); Hui HE, Oakland Charter Township, MI (US); Shubha NAGESWARAN, Rochester Hills, MI (US)

(73) Assignee: GM GLOBAL TECHNOLOGY OPERATIONS LLC, Detroit, MI (US)

(21) Appl. No.: 18/355,289

(22) Filed: Jul. 19, 2023

(30) Foreign Application Priority Data
Jan. 16, 2023 (CN) 202310038506.0

(51) Int. Cl. H01M 4/134; H01M 4/133; H01M 4/525; H01M 4/62; H01M 4/80

(52) U.S. Cl. CPC H01M 4/134; H01M 4/133; H01M 4/525; H01M 4/623; H01M 4/80; H01M 2004/027

(57) ABSTRACT

A negative electrode for an electrochemical cell that cycles lithium includes a negative electrode including an electroactive material layer disposed on a current collector that has lithiated silicon oxide (LSO) negative electroactive material at ≥ about 10 weight % to ≤ about 30 weight % of a total weight of the electroactive material layer and a carbonaceous negative electroactive material, such as graphite. An electrochemical cell that incorporates such a negative electrode may also include a second electrode comprising a porous positive active material layer comprising a positive lithium containing, nickel-rich electroactive material, such as a lithium nickel manganese cobalt aluminum oxide, a porous separating layer disposed between the first electrode and the second electrode and an electrolyte disposed in pores of the separating layer.

### CROSS-REFERENCE TO RELATED APPLICATIONS

This application claims the benefit and priority of Chinese Application No. 202310038506.0, filed Jan. 16, 2023. The entire disclosure of the above application is incorporated herein by reference.

### INTRODUCTION

This section provides background information related to the present disclosure which is not necessarily prior art.

The present disclosure relates to lithium-ion electrochemical cells having high-energy capacity and fast charging capacity, which include a negative electrode or anode comprising a lithiated silicon oxide (LSO) negative electroactive material.

High-energy density electrochemical cells, such as lithium-ion batteries can be used in a variety of consumer products and vehicles, such as hybrid or electric vehicles including for example, start-stop systems (e.g., 12 V start-stop systems), battery-assisted systems, hybrid electric vehicles (“HEVs”), and electric vehicles (“EVs”). Typical lithium-ion batteries comprise at least one positive electrode or cathode, at least one negative electrode or an anode, an electrolyte material, and a separator. A stack of lithium-ion battery cells may be electrically connected in an electrochemical device to increase overall output. Lithium-ion batteries operate by reversibly passing lithium ions between the negative electrode and the positive electrode. A separator filled with a liquid or solid electrolyte may be disposed between the negative and positive electrodes. The electrolyte is suitable for conducting lithium ions between the electrodes and may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Lithium ions move from a cathode (positive electrode) to an anode (negative electrode) during charging of the battery, and in the opposite direction when discharging the battery. Each of the negative and positive electrodes within a stack is connected to a current collector (typically a metal, such as copper foil for the anode and aluminum foil for the cathode). During battery usage, the current collectors associated with the two electrodes are connected by an external circuit that allows current generated by electrons to pass between the electrodes to compensate for transport of lithium ions.

Many different materials may be used to create components for a lithium ion battery. For example, positive electrode materials for lithium batteries typically comprise an electroactive material which can be intercalated or reacted with lithium ions, such as lithium-transition metal oxides or mixed oxides, for example including LiMn₂O₄, LiCoO₂, LiNiO₂, LiMn_{1.5}Ni_{0.5}O₄, LiNi_{(1-x-y)}CoₓM_{y}O ₂ (where 0<x<1, y<1, and M may be Al, Mn, or the like), or one or more phosphate compounds, for example including lithium iron phosphate or mixed lithium manganese-iron phosphate. The negative electrode typically includes a lithium insertion material or an alloy host material. For hybrid and electric vehicles, the most common electroactive material for forming a negative electrode/anode is graphite that serves as a lithium-graphite intercalation compound. Graphite is the commonly used negative electrode material because of its relatively high specific capacity (approximately 350 mAh/g). However, it is a continual objective to increase energy density and/or power capacity.

One approach to increase the power of lithium-ion electrochemical cells is to create systems that include electrodes having a high energy capacity or density, meaning an amount of energy the battery can store with respect to its mass (watt-hours per kilogram (Wh/kg)). Power capacity or density is an amount of power that can be generated by the battery with respect to its mass (watts per kilogram (W/kg)). It would be desirable to have a negative electrode in an electrochemical cell that can exhibit both high energy/high specific capacity and as well as high power/fast charging capacity and recharging capabilities, especially for plug-in hybrid and electric vehicle applications where rapid charging at charging stations may be desirable.

### SUMMARY

This section provides a general summary of the disclosure, and is not a comprehensive disclosure of its full scope or all of its features.

The present disclosure relates to electrochemical cell that cycle lithium ions having new negative electrodes. Such a negative electrode may include a current collector and an electroactive material layer disposed on the current collector. The negative electroactive material layer includes a lithiated silicon oxide (LSO) negative electroactive material at greater than or equal to about 10 weight % to less than or equal to about 30 weight % of a total weight of the electroactive material layer and a carbonaceous negative electroactive material.

In one aspect, the lithiated silicon oxide (LSO) is represented by a formula Li_{y}SiOₓ, where 0<y<1 and 0<x<2.

In one aspect, the carbonaceous electroactive material includes graphite present at greater than or equal to about 70 weight % of a total weight of the electroactive material layer.

In one aspect, the electroactive material layer further includes an electrically conductive particle.

In one further aspect, the electrically conductive particle includes carbon and is selected from the group consisting of: carbon black, graphene, carbon nanoplates, carbon nanotubes, and combinations thereof.

In one aspect, the electroactive material layer further includes a polymeric binder selected from the group consisting of: polyvinylidene difluoride (PVDF), poly(vinylidene fluoride-co-hexafluoropropylene) (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymer (SEBS), polyethylene glycol (PEO), polyacrylic acid (PAA), lithium polyacrylate (LiPAA), sodium polyacrylate (NaPAA), copolymers, and combinations thereof.

In one aspect, the electroactive material layer is a porous composite layer that includes the lithiated silicon oxide (LSO) negative electroactive material and the carbonaceous negative electroactive material distributed in a matrix of a polymeric binder.

In one further aspect, the polymeric binder is selected from the group consisting of: styrene-butadiene rubber (SBR), sodium carboxymethyl cellulose (CMC), polyacrylic acid (PAA), lithium polyacrylate (LiPAA), sodium polyacrylate (NaPAA), copolymers, and combinations thereof.

In one aspect, the electroactive material layer includes a cumulative amount of the lithiated silicon oxide (LSO) and the carbonaceous negative electroactive material at greater than or equal to about at 90 weight % to less than or equal to about 98 weight % of a total weight of the electroactive material layer.

In one aspect, the carbonaceous negative electroactive material includes graphite. The negative electroactive material layer further includes a cumulative amount of the lithiated silicon oxide (LSO) and the graphite at greater than or equal to about at 90 weight % to less than or equal to about 98 weight % of a total weight of the electroactive material layer, a polymeric binder at greater than or equal to about at 1 weight % to less than or equal to about 10 weight % of a total weight of the electroactive material layer, and a plurality of electrically conductive particles including carbon including a single walled carbon nanotube (SWCNT) at greater than or equal to about at 0.05 weight % to less than or equal to about 1 weight % of a total weight of the electroactive material layer. Further, a cumulative amount of other electrically conductive particles including carbon present at greater than or equal to about at 1 weight % to less than or equal to about 5 weight % of a total weight of the electroactive material layer.

In one aspect, the electroactive material layer on one side of the current collector has a capacity loading of a total amount of negative electroactive materials at greater than or equal to about 3.3 mAh/cm² for a 0.1C rate at 21° C., the electroactive material has a press density of greater than or equal to about 1.4 g/cm³ and a porosity of greater than or equal to about 25%.

In other aspects, the present disclosure relates to an electrochemical cell that cycles lithium ions. The electrochemical cell includes a first electrode including a first current collector having a porous negative active material layer disposed thereon. The porous negative active material layer includes a lithiated silicon oxide (LSO) negative electroactive material at greater than or equal to about 10 weight % to less than or equal to about 30 weight % of a total weight of the porous negative active material layer and a carbonaceous negative electroactive material. The electrochemical cell also includes a second electrode including a porous positive active material layer including a positive lithium containing, nickel-rich electroactive material. The electrochemical cell also includes a porous separating layer disposed between the first electrode and the second electrode an electrolyte disposed in pores of the separating layer.

In one aspect, the positive lithium-containing, nickel-rich electroactive material includes a lithium nickel manganese cobalt aluminum oxide represented by a formula of LiNiₓCo_{y}Mn_{z}Al_{(1-x-y-z)}O₂, where x is greater than or equal to about 0.8 and less than or equal to about 1, y is greater than 0 and less than or equal to about 0.2, and z is greater than 0 and less than or equal to about 0.2.

In one aspect, the positive lithium-containing, nickel-rich electroactive material includes a lithium nickel manganese cobalt aluminum oxide represented by a formula of LiNiₓCo_{y}Mn_{z}Al_{(1-x-y-z)}O₂ where 0.8≤x≤1, more particularly 0.83≤x≤1, 0≤y≤0.17, and 0≤z≤0.17.

In one aspect, the lithiated silicon oxide (LSO) is represented by a formula Li_{y}SiOₓ, where 0<y<1 and 0<x<2 and the carbonaceous electroactive material includes graphite present at greater than or equal to about 70 weight % of a total weight of the electroactive material layer.

In one aspect, the porous negative active material layer further includes an electrically conductive particle including carbon selected from the group consisting of: carbon black, graphene, carbon nanoplates, carbon nanotubes, and combinations thereof and the porous positive active material layer further includes an electrically conductive particle including carbon selected from the group consisting of: carbon black, graphite, graphene, carbon nanoplates, carbon nanotubes, and combinations thereof.

In one aspect, the porous negative active material layer and the porous positive active material layer each further includes a polymeric binder independently selected from the group consisting of: polyvinylidene difluoride (PVDF), poly(vinylidene fluoride-co-hexafluoropropylene) (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymer (SEBS), polyethylene glycol (PEO), polyacrylic acid (PAA), lithium polyacrylate (LiPAA), sodium polyacrylate (NaPAA), copolymers, and combinations thereof.

In one aspect, the electrolyte includes at least one lithium salt and at least one organic solvent, the at least one lithium salt selected from the group consisting of: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiFSI), lithium bis(trifluoromethanesulfonyl)imide (LiTFSI), and combinations thereof, and the at least one solvent selected from the group consisting of: cyclic carbonates, linear carbonates, aliphatic carboxylic esters, gamma (γ)-lactones, chain structure ethers, cyclic ethers, sulfur compounds, and combinations thereof.

In one aspect, the electrochemical cell has a capacity ratio of first electrode (N) to second (P) electrode (N/P ratio) of greater than or equal to about 1 to less than or equal to about 1.2.

In further aspects, the present disclosure relates to an electrochemical cell that cycles lithium ions that includes a first electrode including a first current collector having a porous negative active material layer disposed thereon that includes a cumulative amount of negative electroactive materials at greater than or equal to about at 90 weight % to less than or equal to about 98 weight % of a total weight of the electroactive material layer. The negative electroactive materials include a lithiated silicon oxide (LSO) negative electroactive material at greater than or equal to about 10 weight % to less than or equal to about 30 weight % of a total weight of the porous negative active material layer and graphite at greater than or equal to about 70 weight % to less than or equal to about 90 weight % of a total weight of the porous negative active material layer. A second electrode includes a porous positive active material layer including a lithium nickel manganese cobalt aluminum oxide represented by a formula of LiNiₓCo_{y}Mn_{z}Al_{(1-x-y-z)}O₂, where x is greater than or equal to about 0.8 and less than or equal to about 1, y is greater than 0 and less than or equal to about 0.2, and z is greater than 0 and less than or equal to about 0.2. The electrochemical cell also includes a porous separating layer disposed between the first electrode and the second electrode and an electrolyte disposed in pores of the separating layer. The electrochemical cell has an energy density of greater than or equal to about 290 Wh/kg.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an example of a single electrochemical battery cell for cycling lithium ions;

FIG. 2 shows voltage (V) versus capacity (A/h) in an electrochemical battery pouch cell example prepared in accordance with certain aspects of the present disclosure tested to show an initial Coulombic Efficiency (C.E.) and an initial discharge capacity;

FIG. 3 shows capacity retention (%) versus charge-discharge cycle number for testing of an example of the electrochemical battery pouch cell prepared in accordance with certain aspects of the present disclosure;

FIG. 4 shows a Coulombic Efficiency (%) versus charge-discharge cycle number for an example of the electrochemical battery pouch cell prepared in accordance with certain aspects of the present disclosure;

FIG. 5 shows a cell swelling ratio (%) for an example of the electrochemical battery pouch cell prepared in accordance with certain aspects of the present disclosure prior to and after 500 charge-discharge cycles; and

FIG. 6 shows state of charge (SOC)(%) versus time (minutes) for an example of the electrochemical battery pouch cell prepared in accordance with certain aspects of the present disclosure demonstrating fast charging capability.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” maybe intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

High-energy density electrochemical cells, such as batteries that cycle lithium ions, can be used in a variety of consumer products and vehicles, such as hybrid or electric vehicles. In certain aspects, the present disclosure provides new high-performance electrochemical cell that cycles lithium ions, such as lithium-ion battery cell designs, that incorporate new negative electrodes. These negative electrodes may be paired with high-performance positive electrodes to provide electrochemical cells that exhibit various advantages, including by way of non-limiting example, improved cell energy density, enhanced cyclability/capacity retention, fast charge capability, and the ability to design cells with low or no compressive force (applied) pressure during the cycle test, module assembling, and regular operation.

Such high performance batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

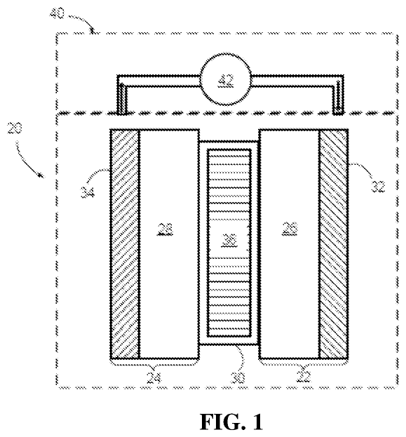

Typical batteries comprise at least one positive electrode or cathode, at least one negative electrode or anode, an electrolyte material, and optionally, a separator. A stack of lithium-ion battery cells may be electrically connected in an electrochemical device to increase overall output (for example, typically they are connected in parallel to increase current output). By way of background, an exemplary and schematic illustration of an electrochemical cell (also referred to as a battery) 20 is shown in FIG. 1. Although the illustrated examples include a single positive electrode or cathode and a single negative electrode or anode, the skilled artisan will recognize that the present disclosure also contemplates various other configurations, including those having one or more cathodes and one or more anodes, as well as various current collectors with electroactive layers disposed on or adjacent to one or more surfaces thereof.

A typical lithium ion battery 20 includes a first electrode (such as an anode or negative electrode assembly 22 that includes a negative active material layer 26 or anode material) disposed on a negative current collector 32 opposing a second electrode (such as a cathode or positive electrode assembly 24 that includes a positive active material layer 28 or cathode material) disposed on a positive current collector 34. A separator 36 and/or electrolyte 30 are disposed between the first electrode and the second electrode therebetween. While not shown, often in a lithium ion battery pack, batteries or cells may be electrically connected in a stack or winding configuration to increase overall output. Lithium ion batteries operate by reversibly passing lithium ions between the first and second electrodes. For example, lithium ions may move from the positive electrode 24 to the negative electrode 22 during charging of the battery, and in the opposite direction when discharging the battery. The electrolyte 30 is suitable for conducting lithium ions and may be in liquid, gel, or solid form.

When a liquid or semi-liquid/gel electrolyte is used, the separator 36 (e.g., a microporous polymeric separator) is thus disposed between the two electrodes 22, 24 and may comprise the electrolyte 30, which may also be present in the pores of the negative active material layer 26 of the negative electrode 22 and in pores of the positive active material layer 28 of the positive electrode 24. When a solid electrolyte is used, the microporous polymeric separator 36 may be omitted. The solid-state electrolyte may also be mixed into the negative active material layer 26 of the negative electrode 22 and the positive active material layer 28 of the positive electrode 24. Likewise, a liquid or semi-liquid/gel electrolyte may imbibe or fill pores within the negative active material layer 26 of the negative electrode 22 and/or the positive active material layer 28 of the positive electrode 24.

The negative electrode current collector 32 may be positioned at or near the negative active material layer 26 and the positive electrode current collector 34 may be positioned at or near the positive active material layer 28. An interruptible external circuit 40 and a load device 42 connects the negative electrode 22 (through its current collector 32) and the positive electrode 24 (through its current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 36 towards the positive electrode 24. The electrons flow through the external circuit 40 and the lithium ions migrate across the separator 36 containing the electrolyte solution 30 to form intercalated lithium at the positive electrode 24. As noted above, electrolyte 30 is typically also present in the negative active material layer 26 of the negative electrode 22 and positive active material layer 28 of the positive electrode 24. The electric current passing through the external circuit 40 can be harnessed and directed through the load device 42 until the lithium in the negative electrode 22 is depleted and the capacity of the battery 20 is diminished.

The load device 42 may thus be powered by the electric current passing through the external circuit 40 when the battery 20 is discharging. While the electrical load device 42 may be any number of known electrically powered devices, a few specific examples include an electric motor for an electrified vehicle, a laptop computer, a tablet computer, a cellular phone, and cordless power tools or appliances. The load device 42 may also be an electricity generating apparatus that charges the battery 20 for purposes of storing electrical energy.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of transition metal ions, at the positive electrode 24 so that electrons and lithium ions are produced. The lithium ions flow from the negative electrode 22 through the electrolyte 30 across the separator 36 to replenish the positive electrode 24 with lithium for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC DC converter connected to an AC electrical power grid though a wall outlet and a motor vehicle alternator.

In many lithium ion battery configurations, each of the negative electrode current collector 32, negative active material layer 26, the separator 36, positive active material layer 28, and positive electrode current collector 34 are prepared as relatively thin layers (for example, from several microns to a fraction of a millimeter or less in thickness) and assembled in layers connected in electrical parallel arrangement to provide a suitable electrical energy and power package. The negative electrode current collector 32 and positive electrode current collector 34 respectively collect and move free electrons to and from an external circuit 40.

Further, as noted above, when a liquid or semi-liquid electrolyte is used, the separator 36 operates as an electrical insulator by being sandwiched between the negative electrode 22 and the positive electrode 24 to prevent physical contact and thus, the occurrence of a short circuit. The separator 36 provides not only a physical and electrical barrier between the two electrodes 22, 24, but also contains the electrolyte solution in a network of open pores during the cycling of lithium ions, to facilitate functioning of the battery 20. Alternatively, a solid-state electrolyte layer may be used that may serve a similar ion conductive and electrically insulating function, but without needing a separator 36 component.

The battery 20 can include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 36. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

In FIG. 1, the positive active material layer 28 of the positive electrode 24, the negative active material layer 26 of the negative electrode 22, and the separator 36 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. In certain aspects, the electrolyte 30 may be a non-aqueous liquid electrolyte solution (e.g., greater than or equal to about 0.8 mol/L (M) to less than or equal to about 1.2 M, and in certain aspects, optionally about 1 M) that includes a lithium salt dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiFSI), lithium bis(trifluoromethanesulfonyl)imide (LiTFSI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran, 1,3-dioxolane), sulfur compounds (e.g., sulfolane), and combinations thereof. In one variation, the solvent is a carbonate ester, such as ethylene carbonate (EC), propylene carbonate (PC), butylene carbonate (BC), fluoroethylene carbonate (FEC), dimethyl carbonate (DMC), diethyl carbonate (DEC), ethylmethylcarbonate (EMC), and combinations thereof.

In certain variations, the electrolyte 30 may further include an electrolyte additive. For example, the electrolyte 30 may include greater than or equal to about 0.1 wt. % to less than or equal to about 10 wt. %, and in certain aspects, optionally greater than or equal to 0.1 wt. % to less than or equal to 10 wt. %, of an electrolyte additive. The electrolyte additive may include vinylene carbonate (VC), vinylethylene carbonate (VEC), ethylene sulfate (DTD), 1,3-propone sulfone (PS), tris(trimethylsilyl) phosphite (TMSPi), trimethylene sulfate (TMS), succinonitrile (SN), triphenylamine (Ph₃N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof.

In one variation, the electrolyte 30 may comprises lithium hexafluorophosphate (LiPF₆) in a solvent comprising a carbonate ester. The lithium hexafluorophosphate (LiPF₆) may be present in the electrolyte at greater than or equal to about greater than or equal to about 0.8 mol/L (M) to less than or equal to about 1.2 M, optionally at about 1 M. The electrolyte may further comprise any combination of the following additional components: fluoroethylene carbonate (FEC), vinylene carbonate (VC), ethylene sulfate (DTD), tris(trimethylsilyl) phosphite (TMSPi), lithium bis(oxalato)borate (LiB(C₂O₄)₂) (LiBOB), lithium bis(fluorosulfonyl)imide (LiFSI), lithium bis(trifluoromethanesulfonyl)imide (LiTFSI), and the like.

By way of non-limiting example, one suitable example of an electrolyte 30 may include 1 M LiPF₆, EC/DMC at a volume ratio of 3:7, FEC at 2 wt. %, VC 1 wt. and TMSPi at 1 wt. %. In one further example, such an electrolyte may also include LiBOB at 1 wt. % and/or DTD at 1 wt. %.

The porous separator 36 may have a porosity greater than or equal to about 35 vol.% to less than or equal to about 55 vol.%, and in certain aspects, optionally greater than or equal to about 40 vol. % to 45 vol.%. The separator 36 may have a porosity greater than or equal to 35 vol.% to less than or equal to 55 vol.%, and in certain aspects, optionally 45 vol.%. For example, in certain variations, the porous separator 36 may include a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes 36 include CELGARD® 2500 (a monolayer polypropylene separator), CELGARD® 2320 (a trilayer polypropylene/polyethylene/polypropylene separator), and CELGARD® H2010 (a trilayer microporous polypropylene/polyethylene/polypropylene separator), all of which are commercially available from Celgard LLC.

In certain aspects, the separator 36 may further include one or more of a ceramic coating layer, a heat resistant material coating, and a polymer coating layer. The ceramic coating layer and/or the heat resistant material coating may be disposed on one or more sides of the separator 36. The material forming the ceramic layer may be selected from the group consisting of: alumina (Al₂O₃), silica (SiO₂), and combinations thereof. The heat resistant material may be selected from the group consisting of: NOMEX™ aramid, ARAMID polyamide, and combinations thereof.

When the separator 36 is a microporous polymeric separator, it may be a single layer or a multi-layer laminate, which may be fabricated from either a dry or a wet process. For example, in certain instances, a single layer of the polyolefin may form the entire separator 36. In other aspects, the separator 36 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 36. The separator 36 may also comprise other polymers in addition to the polyolefin such as, but not limited to, polyethylene terephthalate (PET), polyvinylidene fluoride (PVDF), a polyamide, polyimide, poly(amide-imide) copolymer, polyetherimide, and/or cellulose, poly(acrylic acid) (PAA), lithium polyacrylate (LiPAA), sodium polyacrylate (NaPAA), or any other material suitable for creating the required porous structure. Further, the separator 36 may be coated with or have a distinct polymer layer formed from these materials. The polyolefin layer, and any other optional polymer layers, may further be included in the separator 36 as a fibrous layer to help provide the separator 36 with appropriate structural and porosity characteristics. In certain aspects, the separator 36 may also be mixed with a ceramic material or its surface may be coated in a ceramic material. For example, a ceramic coating may include alumina (Al₂O₃), silicon dioxide (SiO₂), titania (TiO₂), Boehmite (γ-AlO(OH)), or combinations thereof. Various conventionally available polymers and commercial products for forming the separator 36 are contemplated, as well as the many manufacturing methods that may be employed to produce such a microporous polymer separator 36.

In certain aspects, the separator can be any combination of a separator having a ceramic layer and/or polymer coating layer. For a coated-type separator, the structure of the separator can be a double-sided coated separator with the same or different coating layers on each side having any of the following configurations, by way of example: a polymer layer/separator/polymer layer, a polymer layer and ceramic layer/separator/polymer layer and ceramic layer, a polymer layer/ceramic layer/separator/ceramic layer/polymer layer, polymer layer/separator/polymer and ceramic layer; a polymer layer/separator/ceramic layer/polymer layer, and the like. In other aspects, the separator can be a single-sided coated separator, for example, having any of the following configurations: polymer layer/separator, polymer layer and ceramic layer/separator layer or polymer layer/ceramic layer/separator, and the like. A thickness of a polymer coated layer over the separator may be greater than or equal to about is 1 μm to less than or equal to about 5 μm, optionally greater than or equal to about 1 μm to less than or equal to about 3 μm.

The separator 36 may have a total thickness of greater than or equal to about 10 micrometers (μm) to less than or equal to about 30 μm, and in certain instances, optionally about 20 μm.

In one variation, a separator may have a total thickness of about 15 μm, for example, having a polymer coating comprising PVDF with a thickness of about 1 μm on a first side, a Boehmite ceramic layer with a thickness of about 2 μm on a first side, a polyethylene (PE) porous separator with a thickness of about 9 μm, a Boehmite ceramic layer with a thickness of about 2 μm on a second side, and a final PVDF coating with a thickness of about 1 μm on a second side. A porosity of the porous PE separator is about 48 vol. %, and having a polymer coating/layer comprising PVDF on both sides, each having a thickness of about 1 μm. In another variation, a separator may have a total thickness of about 20 μm without any coatings, for example, a trilayer microporous membrane (PP/PE/PP), which is commercially available as CELGARD® H2010. This microporous separator may have a porosity of about 46 vol. %, and not have any ceramic coating.

In alternative aspects, the porous separator 36 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. The SSE may be a solid-state inorganic compound or a solid-state polymer electrolyte. By way of non-limiting example, SSEs may include may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99} Ba_{0.005}ClO, or combinations thereof. The solid-state electrolyte may also comprise polyethylene oxide (PEO) based polymers, polycarbonates, polyesters, polynitriles (e.g., polyacrylonitrile (PAN)), polyalcohols (e.g., polyvinyl alcohol (PVA)), polyamines (e.g., polyethyleneimine (PEI)), polysiloxane (e.g., polydimethylsiloxane (PDMS)) and fluoropolymers (e.g., polyvinylidene fluoride (PVDF), polyvinylidene fluoride-hexafluoropropylene (PVDF-HFP)), bio-polymers like lignin, chitosan and cellulose, and any combinations thereof.

As noted above, in various aspects, the present disclosure provides new high-performance negative electrode 22. The negative electrode 22 includes the negative active material layer 26 that is a lithium host material capable of functioning as a negative terminal of a lithium ion battery. The negative active material layer 26 may be formed from a lithium host material that is capable of functioning as a negative terminal of a lithium-ion battery. The negative active material layer 26 may be a relatively nonporous layer of the negative active material or may be a porous electrode composite and include the negative electrode active material(s) and, optionally, an electrically conductive material or other filler, as well as one or more polymeric binder materials to structurally hold the lithium host electroactive material particles together.

The negative active material layer 26 may comprise a first negative electroactive material and a second negative electroactive material. The first negative electroactive material comprises silicon. Thus, the negative active material layer 26 may include silicon-containing (or silicon-based) electroactive material particles. The silicon-containing electroactive materials may include silicon, lithium-silicon alloys, and/or other silicon-containing binary and/or ternary alloys. In certain variations, the negative active material layer 26 comprises a lithium doped silicon oxide, also referred to as a lithiated silicon oxide (LSO). The lithiated silicon oxide (LSO) may be represented by a formula: Li_{y}SiOₓ, where 0<y<1 and 0<x<2. In certain variations, the silicon-containing electroactive materials may be provided as nano-particles, nano-fibers, nano-tubes, and/or micro-particles.

In certain variations, the lithiated silicon oxide (LSO) negative electroactive particle may have an average diameter (D) or D50 (meaning a cumulative 50% point of diameter (or 50% pass particle size)) of greater than or equal to about 3 μm to less than or equal to about 20 μm, total surface area measured via the Brunauer-Emmett-Teller (BET) method using nitrogen (N₂) of greater of greater than or equal to about 0.5 m²/g to less than or equal to about 10 m²/g, and a tapped density of greater than or equal to about 0.8 g/cm³ to less than or equal to about 1.5 g/cm³. In one variation, the lithiated silicon oxide (LSO) negative electroactive particle may have a D50 about 8.3 μm, a total surface area BET of 1.3 m²/g, and a tapped density of about 1.3 g/cm³. In another variation, the lithiated silicon oxide (LSO) negative electroactive particle may have a D50 about 8.7 μm, a total surface area BET of 0.84 m²/g, and a tapped density of about 1.27 g/cm³.

The lithiated silicon oxide (LSO) may be present in the negative active material layer at greater than or equal to about 10 weight % (or wt. % also used interchangeably herein with respect to mass) to less than or equal to about 30 wt. % of a total cumulative weight of the negative electroactive materials present in the negative active material layer. By way of example, the lithiated silicon oxide may be present at 10% by weight, optionally at 15% by weight, optionally at 20% by weight, optionally at 25% by weight, or optionally at 30% of the total cumulative weight of the negative electroactive materials.

In various aspects, the second negative active material layer 26 layer may further include the second negative electroactive material. For example, the second negative electroactive material may include a carbonaceous electroactive material like graphite, hard carbon, and/or soft carbon. In certain variations, the negative active material layer 26 further comprises graphite. The carbonaceous material, like graphite, may be present in the negative active material layer at greater than or equal to about 70 wt. % to less than or equal to about 90 wt. % of a total cumulative weight of the negative electroactive materials. By way of example, the graphite may be present at 70% by weight, optionally at 75% by weight, optionally at 80% by weight, optionally at 85% by weight, or optionally at 90% of the total cumulative weight of the negative electroactive materials.

In certain variations, the graphite negative electroactive particle may have an average diameter (D) or D50 of greater than or equal to about 6 μm to less than or equal to about 20 μm, total surface area BET of greater of greater than or equal to about 1 m²/g to less than or equal to about 10 m²/g, and a tapped density of greater than or equal to about 0.5 g/cm³ to less than or equal to about 1.5 g/cm³. In one variation, the graphite negative electroactive particle may have a D50 about 8.3 μm, a total surface area BET of 1.3 m²/g, and a tapped density of about 1.3 g/cm³. In another variation, the graphite negative electroactive particle may have a D50 about 13 μm, a total surface area BET of 1.5 m²/g, and a tapped density of about 1 g/cm³.

A composite negative electrode may comprise the negative electrode active materials present at greater than about 70 wt. % of the overall weight of the electroactive material of the electrode (not including the weight of the current collector), optionally greater than or equal to about 75 wt. %, optionally greater than or equal to about 80 wt. %, optionally greater than or equal to about 85 wt. %, optionally greater than or equal to about 90 wt. %, optionally greater than or equal to about 95 wt. %, optionally greater than or equal to about 97 wt. %, and in certain variations, optionally greater than or equal to about 98% of the overall weight of the electroactive material layer of the electrode. In certain variations, a cumulative amount of the negative electroactive materials in the negative active material layer 26, including the first electroactive material (e.g., lithiated silicon oxide (LSO)) and the second electroactive material (e.g., the carbonaceous negative electroactive material) may be greater than or equal to about at 90 wt. % to less than or equal to about 98 wt. % of a total weight of the electroactive material layer.

Such negative electrode active materials may be optionally intermingled with one or more electrically conductive materials that provide an electron conduction path and/or at least one polymeric binder material that improves the structural integrity of the composite that forms the negative active material layer 26. Thus, the negative active material layer 26 may be a porous composite layer that comprises the lithiated silicon oxide (LSO) negative electroactive material particles and the carbonaceous negative electroactive material (e.g., graphite) particles intermingled with and distributed in a matrix of a polymeric binder material.

The polymeric binder material may be selected from the group consisting of: polyvinylidene difluoride (PVDF), poly(vinylidene fluoride-co-hexafluoropropylene) (PVDF-HFP), polytetrafluoroethylene (PTFE), carboxymethoxyl cellulose (CMC), such as sodium carboxymethyl cellulose, ethylene propylene diene monomer (EPDM) rubber, nitrile butadiene rubber (NBR), styrene-butadiene rubber (SBR), styrene ethylene butylene styrene copolymer (SEBS), polyethylene glycol (PEO), polyethylene (PE), polyamide, polyimide, sodium alginate, lithium alginate, polyacrylic acid (PAA), lithium polyacrylate (LiPAA), sodium polyacrylate (NaPAA), copolymers, and combinations thereof.

In certain aspects, the polymeric binder that is used to form the negative active material layer 26 may be aqueous and water soluble, making it more environmentally friendly. In such variations, the polymeric binder is selected from the group consisting of: styrene-butadiene rubber (SBR), carboxymethyl cellulose (CMC), polyacrylic acid (PAA), lithium polyacrylate (LiPAA), sodium polyacrylate (NaPAA), copolymers, and combinations thereof. More specifically, the polymer binder may be PAA, a copolymer of styrene-butadiene rubber (SBR) and carboxymethyl cellulose (CMC), a copolymer of styrene-butadiene rubber (SBR), carboxymethyl cellulose (CMC), and sodium polyacrylate (NaPAA) and sodium polyacrylate (NaPAA), and polyacrylic acid (PAA), and the like.

The porous composite structure defining the positive active layer may also include an electrically conductive material, such as a plurality of electrically conductive particles distributed therein. Electrically conductive materials may include, for example, carbon-based materials or a conductive polymer. Carbon-based materials suitable for the negative electrode may include, for example, particles of acetylene black (such as, KETCHEN™ black or DENKA™ black), carbon fibers, carbon nanoplatelets/plates, and carbon nanotubes (CNTs, including single walled CNTs (SWCNT) and multiwalled CNTs (MWCNTs), graphene, graphene oxide, graphite, carbon black (such as, Super P™), and the like. Examples of a conductive polymer may include polyaniline, polythiophene, polyacetylene, polypyrrole, and the like. Conductive metal particles may include nickel, gold, silver, copper, aluminum, and the like.

In certain aspects, particularly suitable electrically conductive particles comprise a carbon black, for example, having a surface area of greater than or equal to about 50 m²/g (BET). One such electrically conductive carbon black is Super P carbon black conductive filler commercially available from Imerys Ltd. having a surface area of greater than about 63.5 m²/g (BET). In certain other aspects, the electrically conductive particle comprises a carbon nanotube (CNT). In yet other aspects, the electrically conductive particles distributed in the negative active layer may comprise carbon and may be selected from the group consisting of: carbon black, graphene, carbon nanoplates, carbon nanotubes, and combinations thereof. In one variation, the negative electroactive material may comprise a carbon black conductive filler particle, like Super P™ and a carbon nanotube (CNT), such as a SWCNT.

Each of the electrically conductive particles may be present at greater than or equal to about 0 wt. % to less than or equal to about 10 wt. %, optionally, greater than or equal to about 0.1 wt. % to less than or equal to about 10 wt. %, and in certain aspects, optionally greater than or equal to about 0 wt. % to less than or equal to about 0.5 wt. % of a total weight of the negative active material layer 26. A cumulative amount of all electrically conductive particles in the positive active layer may be greater than or equal to about to about 0.5 wt. % to less than or equal to about 10 wt. %, and in certain aspects, optionally greater than or equal to about 1 wt. % to less than or equal to about 6 wt. %. While the electrically conductive materials may be described as powders, these materials can lose their powder-like character following incorporation into the electrode, where the associated particles of the supplemental electrically conductive materials become a component of the resulting electrode structure.

The polymeric binder may be present in the negative active material layer 26 at greater than or equal to about 1 wt. % to less than or equal to about 20 wt. %, optionally greater than or equal to about 1 wt. % to less than or equal to about 10 wt. %, optionally greater than or equal to about 1 wt. % to less than or equal to about 8 wt. %, optionally greater than or equal to about 1 wt. % to less than or equal to about 7 wt. %, optionally greater than or equal to about 1 wt. % to less than or equal to about 6 wt. %, optionally greater than or equal to about 1 wt. % to less than or equal to about 5 wt. %, or optionally greater than or equal to about 1 wt. % to less than or equal to about 3 wt. % of the total weight of the electroactive material layer of the electrode.

For example, in certain variations, the negative electrode 22 may include a plurality of solid-state electrolyte particles dispersed with the negative electroactive material particles. In each instance, the negative active material layer 26 of the negative electrode 22 (including the one or more layers) may have a thickness greater than or equal to about 30 μm to less than or equal to about 500 μm, and in certain aspects, optionally greater than or equal to about 50 μm to less than or equal to about 100 μm.

In one embodiment, the negative active material layer 26 may have a cumulative amount of the lithiated silicon oxide (LSO) and the graphite at greater than or equal to about at 90 wt. % to less than or equal to about 98 wt. % of a total weight of the electroactive material layer. The negative active material layer 26 further has a polymeric binder at greater than or equal to about at 1 wt. % to less than or equal to about 10 wt. % of a total weight of the electroactive material layer. The polymeric binder may comprises sodium polyacrylate (NaPAA), carboxymethyl cellulose (CMC), and styrene-butadiene rubber (SBR). In one variation, the NaPAA/CMC/SBR may be present at an approximate 1.7:1.4:1.8 mass ratio. The negative active material layer 26 also comprises a plurality of electrically conductive particles comprising carbon including a single wall carbon nanotube (SWCNT) at greater than or equal to about at 0.05 wt. % to less than or equal to about 1 wt. % of a total weight of the electroactive material layer and a cumulative amount of other electrically conductive particles comprising carbon present at greater than or equal to about at 1 wt. % to less than or equal to about 5 wt. % of a total weight of the electroactive material layer.

In one particular variation, the negative active material layer 26 may have lithiated silicon oxide (LSO) present at about 10 wt. % (e.g., 9.45 wt. %) and graphite at about at about 90 wt. % (e.g., 85.05 wt. %) of the electroactive material layer. The negative active material layer 26 further has a polymeric binder with a combination of polyacrylic acid (PAA) present at about 1.7 wt. %, sodium carboxymethyl cellulose (CMC) present at about 1.4 wt. %, and styrene-butadiene rubber (SBR) present at about 1.8 wt. %. The negative active material layer 26 further comprises a plurality of single wall carbon nanotube (SWCNTs) at about at 0.1 wt. % and carbon black (such as, Super P™) at about 0.5 wt. %.

In one further variation, the negative active material layer 26 may have lithiated silicon oxide (LSO) present at about 20 wt. % (e.g., 18.9 wt. %) and graphite at about at about 80 wt. % (e.g., 75.6 wt. %) of the electroactive material layer. The negative active material layer 26 further has a polymeric binder with a combination of sodium polyacrylate (NaPAA) present at about 1.7 wt. %, sodium carboxymethyl cellulose (CMC) present at about 1.4 wt. %, and styrene-butadiene rubber (SBR) present at about 1.8 wt. %. The negative active material layer 26 further comprises a plurality of single wall carbon nanotube (SWCNTs) at about at 0.1 wt. % and carbon black (such as, Super P™) at about 0.5 wt. %.

In yet another variation, the negative active material layer 26 may have lithiated silicon oxide (LSO) present at about 20 wt. % (e.g., 19.04 wt. %) and graphite at about at about 80 wt. % (e.g., 76.16 wt. %). The negative active material layer 26 further has a polymeric binder with a combination of sodium carboxymethyl cellulose (CMC) present at about 1.2 wt. % and styrene-butadiene rubber (SBR) present at about 3 wt. %. The negative active material layer 26 further comprises a plurality of single wall carbon nanotube (SWCNTs) at about at 0.1 wt. % and carbon black (such as, Super P™) at about 0.5 wt. %.

In yet another variation, the negative active material layer 26 may have lithiated silicon oxide (LSO) present at about 30 wt. % (e.g., 28 wt. %) and graphite at about at about 70 wt. % (e.g., 67.05 wt. %). The negative active material layer 26 further has a polymeric binder with a combination of polyacrylic acid (PAA) present at about 2 wt. %, sodium carboxymethyl cellulose (CMC) present at about 1.5 wt. %, and styrene-butadiene rubber (SBR) present at about 1.3 wt. %. The negative active material layer 26 further comprises a plurality of single wall carbon nanotube (SWCNTs) at about at 0.15 wt. %.

In certain aspects, the negative active material layer 26 layer on one side of the current collector has a capacity loading of a total amount of negative electroactive materials at greater than or equal to about 3.3 mAh/cm² for a 0.1C rate at 21° C. (room temperature), optionally greater than or equal to about 4 mAh/cm², optionally greater than or equal to about 4.4 mAh/cm², optionally greater than or equal to about 5 mAh/cm², optionally greater than or equal to about 5.5 mAh/cm², optionally greater than or equal to about 6 mAh/cm², optionally greater than or equal to about 6.5 mAh/cm², optionally greater than or equal to about 7 mAh/cm², and in certain variations, optionally up to about 7.5 mAh/cm² for a 0.1C rate at 21° C. (room temperature).

In certain aspects, the negative active material layer 26 has a press density of greater than or equal to about 1.4 g/cm³, optionally greater than or equal to about 1.5 g/cm³, greater than or equal to about 1.6 g/cm³, greater than or equal to about 1.7 g/cm³, and in certain variations, up to about 1.8 g/cm³.

A porosity of the composite active material layer, whether the negative active material layer 26 or the positive active material layer 28 after all processing is completed (including consolidation and calendering) may be considered to be a fraction of void volume defined by pores over the total volume of the active material layer. The porosity may be greater than or equal to about 15% by volume to less than or equal to about 50% by volume, optionally greater than or equal to 20% by volume to less than or equal to about 40% by volume, and in certain variations, optionally greater than or equal to 25% by volume to less than or equal to about 35% by volume. In one variation, the negative active material layer 26 has a porosity of greater than or equal to about 25%. In one variation, the negative active material layer 26 has a porosity of about 34%

The negative active material layer 26 may have a moisture content (e.g., water content) prior to the introduction of the electrolyte 30 of less than or equal to about 500 ppm.

The negative electrode current collector 32 can comprise metal, for example, it may be formed from copper (Cu), nickel (Ni), or alloys thereof or any other appropriate electrically conductive material known to those of skill in the art.

In certain aspects, the negative electrode current collector 32 and/or positive electrode current collector (discussed below) may be in the form of a foil, slit mesh, expanded metal a metal grid or screen, and/or woven mesh. Expanded metal current collectors refer to metal grids with a greater thickness such that a greater amount of electrode active material is placed within the metal grid.

In various aspects, the positive active material layer 28 of the positive electrode 24 may include a positive electroactive material, like a lithium based electroactive material, which can sufficiently undergo lithium intercalation and deintercalation, or alloying and dealloying, while functioning as the positive terminal of the battery. One exemplary common class of known materials that can be used to form the electroactive material layer of the positive electrode is layered lithium transitional metal oxides. For example, in certain aspects, the positive active material layer 28 may comprise one or more materials having a spinel structure, such as lithium manganese oxide (Li₍₁₊ₓ₎Mn₍₂₋ₓ₎O₄), where x is typically less than 0.15, including LiMn₂O₄(LMO) and lithium manganese nickel oxide LiMn_{1.5}Ni_{0.5}O₄(LMNO). In other instances, the positive active material layer 28 of the positive electrode 24 may include layered materials like lithium cobalt oxide (LiCoO₂), lithium nickel oxide (LiNiO₂), lithium manganese nickel oxide (LiMn₍₂₋ₓ₎NiₓO₄, where 0≤x≤0.5, abbreviated LMNO) (e.g., LiMn_{1.5}Ni_{0.5}O₄), a lithium nickel manganese cobalt oxide (Li(NiₓMn_{y}Co_{z})O₂), where 0≤x≤1, 0≤y≤1, 0≤z≤1, and x+y+z=1 abbreviated NMC, including LiMn_{0.33}Ni_{0.33}Co_{0.33}O₂, a lithium nickel manganese cobalt aluminum oxide, such as LiNiₓCo_{y}Mn_{z}Al_{(1-x-y-z)}O₂ where 0≤x≤1, optionally 0.8≤x≤1, or more particularly 0.83≤x≤1; 0≤y≤0.2, more particularly 0≤y≤0.17; and 0≤z≤0.2, more particularly 0≤z≤0.17 (abbreviated NCMA or NMCA), such as Li(Ni_{0.89}Mn_{0.05}Co_{0.05}Al_{0.01})O₂ or Li(Ni_{0.9}Mn_{0.03}Co_{0.05}Al_{0.02})O₂, and a lithium nickel cobalt metal oxide (LiNi_{(1-x-y)}CoₓM_{y}O₂), where 0<x<1 and 0<y<1. Other known lithium-transition metal compounds such as lithium iron phosphate (LiFePO₄ abbreviated LFP) or lithium iron fluorophosphate (Li₂FePO₄F), or other phosphate based actives, like lithium manganese-iron phosphate (LiMn₁₋ₓFeₓPO₄, where 0<x<0.4, abbreviated LMFP), lithium iron fluorophosphate (Li₂FePO₄F), or lithium silicate based materials, like orthosilicates, Li₂MSiO₄ (where M is Mn, Fe, Co, Ni or other transition metals) or silicides, like Li₆MnSi₅, and any combinations thereof can also be used.

In certain aspects, the positive active material layer includes a high performance positive electroactive material, such as lithium-containing, nickel-rich layered electroactive materials represented, for example, by a nickel-rich lithium nickel manganese cobalt aluminum oxide, such as LiNiₓMnCoAlO₂, where x is greater than or equal to about 0.8. In one variation, the nickel-rich positive electroactive material may be a lithium nickel manganese cobalt aluminum oxide (NMCA/NCMA) represented by a formula of LiNiₓCo_{y}Mn_{z}Al_{(1-x-y-z)}O₂, where x is greater than or equal to about 0.8 and optionally less than or equal to about 1, y is greater than 0 and less than or equal to about 0.2, and z is greater than 0 and less than or equal to about 0.2. In one variation, the positive lithium-containing, nickel-rich electroactive material comprises a lithium nickel manganese cobalt aluminum oxide represented by a formula of LiNiₓCo_{y}Mn_{z}Al_{(1-x-y-z)}O₂ where 0.8≤x≤1, more particularly 0.83≤x≤1, 0≤y≤0.2, more particularly 0≤y≤0.17, and 0≤z≤0.2, more particularly 0≤z≤0.17, including by way of example, LiNi_{0.9}Co_{0.05}Mn_{0.03}Al_{0.02}O₂.

In certain variations, the positive electroactive materials may be doped (for example, by magnesium (Mg)) or have a coating disposed over each particle surface. For example, the coating may be a carbon containing, oxide containing (e.g., aluminum oxide), fluoride containing, nitride containing or polymeric thin coating disposed over the electroactive material. The coating may be ionically conductive and optionally electrically conductive. The coating may also be applied over the composite electrode (electroactive material layer) after formation in alternative variations.

The positive electroactive materials may be particulate or powder compositions. In certain aspects, the positive electroactive material comprises a nickel-rich lithium nickel manganese cobalt aluminum oxide (NMCA/NCMA) that has a morphology that may include a single crystal, or a secondary particle, or blended types of particles. In certain variations, a blended type of positive electroactive material may include large and small particles, for example, of nickel-rich lithium nickel manganese cobalt aluminum oxide to improve press density and rate capability.

In certain variations, the positive electroactive particle, such as the nickel-rich lithium nickel manganese cobalt aluminum oxide may have an average diameter (D) or D50 of greater than or equal to about 2 μm to less than or equal to about 20 μm, for example, greater than or equal to about 3 to less than or equal to about 15 μm. In one variation, the positive electroactive particles may include a first plurality of nickel-rich lithium nickel manganese cobalt aluminum oxide particles having a first average diameter D50 of about 3.6 μm (smaller particles) and a second plurality of nickel-rich lithium nickel manganese cobalt aluminum oxide particles having a second average diameter D50 of about 13.5 μm (larger particles), so that an average D50 for the blend is about 11.3 μm.

The positive electroactive materials, such as the nickel-rich lithium nickel manganese cobalt aluminum oxide particles may have a total surface area BET of greater of greater than or equal to about 0.3 m²/g to less than or equal to about 1.5 m²/g and a tapped density of greater than or equal to about 1.2 g/cm³ to less than or equal to about 3 g/cm³. In one variation, the nickel-rich lithium nickel manganese cobalt aluminum oxide blend may including two particles (a first particle having a D50 of about 3.6 μm and a second particle having a D50 of about 13.5 μm) has an average D50 of about 11.3 μm, an average total surface area BET of 0.55 m²/g, and an average tapped density of about 2.48 g/cm³. In another variation, the positive electroactive particle may have a D50 about 13 μm, a total surface area BET of 1.5 m²/g, and a tapped density of about 1 g/cm³.

Similar amounts of positive electroactive material particles, electrically conductive materials, and binder may be used as described above in the context of the negative electroactive material particles and other components of the negative electrode 22 to form the positive active material layer 28 of the positive electrode 24 and for brevity will not be repeated herein. However, in addition to the electrically conductive particles described in the context of the negative electrode, the electrically conductive materials comprising carbon for the positive active material layer 28 of the positive electrode 24 may further include conductive graphite, for example, having a surface area of greater than or equal to about 5 m²/g to less than or equal to about 30 m²/g with an average diameter (D) or D50 that is less than or equal to about 8 micrometers (μm). Such a conductive graphite particle is commercially available as TIMCAL TIMREX® KS-6 Synthetic Graphite. Likewise, the positive active material layer 28 of the positive electrode 24 may have similar properties, such as thickness, porosity, and the like to those described in the context of the negative active material layer 26 of the negative electrode 22 unless otherwise specified and therefore will not be repeated.

In one embodiment, the positive active material layer 28 may have a total amount of the positive electroactive material, such as nickel-rich lithium nickel manganese cobalt aluminum oxide (NMCA/NCMA) at greater than or equal to about at 90 wt. % to less than or equal to about 97 wt. % of a total weight of the electroactive material layer. The positive active material layer 28 further may have a polymeric binder at greater than or equal to about at 1 wt. % to less than or equal to about 5 wt. % of a total weight of the electroactive material layer. The positive active material layer 28 also comprises a plurality of electrically conductive particles comprising carbon, such as those described above in the context of the negative active material layer 26 of the negative electrode 22, each independently present at greater than or equal to about at 0.05 wt. % to less than or equal to about 3 wt. % of a total weight of the electroactive material layer and a cumulative amount of all electrically conductive particles (including those comprising carbon) present at greater than or equal to about at 1 wt. % to less than or equal to about 5 wt. % of a total weight of the electroactive material layer.

In one particular variation, the positive active material layer 28 may have a positive electroactive material in the form of nickel-rich lithium nickel manganese cobalt aluminum oxide present at about 95 wt. % (e.g., 94.9 wt. %) of the electroactive material layer. The positive active material layer 28 further has a polymeric binder comprising polyvinylidene fluoride (PVDF) present at about 2 wt. %. The positive active material layer 28 further comprises electrically conductive carbon-containing particles including a carbon black (such as, Super P™) at about 2.5 wt. %, a conductive graphite particle (commercially available as TIMCAL TIMREX® KS-6 Synthetic Graphite) at about 0.5 wt. %, and a single wall carbon nanotube (SWCNT) at about at 0.1 wt. %.

In one additional variation, the positive active material layer 28 may have a positive electroactive material in the form of nickel-rich lithium nickel manganese cobalt aluminum oxide present at about 95 wt. % (e.g., 94.6 wt. %) of the electroactive material layer. The positive active material layer 28 further has a polymeric binder comprising polyvinylidene fluoride (PVDF) present at about 2 wt. %. The positive active material layer 28 further comprises electrically conductive carbon-containing particles including a carbon black (such as, Super P™) at about 2 wt. %, a conductive graphite particle (commercially available as TIMCAL TIMREX® KS-6 Synthetic Graphite) at about 1 wt. %, and a multiwalled carbon nanotube (MWCNT) at about at 0.4 wt. %.

In one further variation, the positive active material layer 28 may have a positive electroactive material in the form of nickel-rich lithium nickel manganese cobalt aluminum oxide present at about 95 wt. % (e.g., 94.9 wt. %) of the electroactive material layer. The positive active material layer 28 further has a polymeric binder comprising polyvinylidene fluoride (PVDF) present at about 2 wt. %. The positive active material layer 28 further comprises electrically conductive carbon-containing particles including a carbon black (such as, Super P™) at about 2 wt. %, a conductive graphite particle (commercially available as TIMCAL TIMREX® KS-6 Synthetic Graphite) at about 1 wt. %, and a single wall carbon nanotube (SWCNT) at about at 0.1 wt. %.

In certain aspects, the positive active material layer 28 on one side of the positive current collector 34 has a capacity loading of a total amount of positive electroactive materials at greater than or equal to about 3 mAh/cm² for a 0.1C rate at 21° C. (room temperature), optionally greater than or equal to about 4 mAh/cm², optionally greater than or equal to about 5 mAh/cm², optionally greater than or equal to about 6 mAh/cm², and in certain variations, optionally up to about 7 mAh/cm² for a 0.1 C rate at 21° C. (room temperature).

In certain aspects, the positive active material layer 28 has a press density of greater than or equal to about 3.2 g/cm³, optionally greater than or equal to about 3.3 g/cm³, optionally greater than or equal to about 3.4 g/cm³, optionally greater than or equal to about 3.5 g/cm³, greater than or equal to about 3.6 g/cm³, greater than or equal to about 3.7 g/cm³, and in certain variations, up to about 3.8 g/cm³. In certain variations, the positive active material layer 28 has a press density of about 3.4 g/cm³.

The positive active material layer 28 may have a moisture content (e.g., water content) prior to the introduction of the electrolyte 30 of less than or equal to about 500 ppm.

The positive electrode current collector 34 may be formed from aluminum or any other appropriate electrically conductive material known to those of skill in the art. It may have any of the forms described above in the context of the negative electrode current collector 32.

When the negative and positive electrodes 22, 24 are assembled with the negative and positive current collectors 32, 24 having a separator 36 disposed therebetween, the electrochemical cell or battery 20 prepared in accordance with various aspects of the present disclosure may have a capacity ratio (e.g., areal capacity) of negative electrode to positive electrode (N/P ratio) of greater than or equal to about 1 to less than or equal to about 1.2, optionally greater than or equal to about 1.05 to less than or equal to about 1.15, optionally about 1.1 in certain variations.

In a conventional slurry casting manufacturing process of an electrode, whether a positive or negative electrode, a slurry is formed and cast onto a current collector. For example, a slurry may be formed by introducing a polymeric binder into a solvent to form a precursor. The electrically conductive particles and electroactive material particles are then added to the precursor to form a dispersion. The amount of solvent in the precursor can be adjusted to form a slurry. The slurry can be mixed or agitated, and then applied to a substrate. The substrate can be a removable substrate or alternatively a functional substrate, such as a current collector (such as a metallic grid or mesh layer). The slurry thus may then be cast onto a current collector, where the solvent is removed to solidify the material and form a composite active layer over the current collector. If the substrate is removable, the porous composite active layer that is formed is removed from the substrate and then further laminated to a current collector. With either type of substrate, it may be necessary to extract or remove the remaining plasticizer prior to incorporation into the battery cell.

In one variation, heat or radiation can be applied to volatilize/evaporate the solvent from the active material film, leaving a solid residue. The porous composite active film may be further consolidated and/or laminated, where heat and pressure are applied to the film to sinter and calendar it. In other variations, the film may be air-dried at moderate temperature to form a film.

While not shown, often in a lithium-ion battery pack, batteries or cells may be electrically connected in a stack where layers are assembled on top of one another or winding configuration (e.g., being wound in a battery) to increase overall output. As noted above, the electrodes can generally be incorporated into various commercial battery designs, such as pouch cells, prismatic shaped cells, stacked cells, wound cylindrical cells, coin cells, or other suitable cell shapes. In certain variations, the present disclosure, the electrochemical cells prepared in accordance with the present disclosure may be formed and assembled together without hot lamination after stacking or winding. In other variations, the electrochemical cells prepared in accordance with the present disclosure may be formed in a process that includes the hot lamination process after stacking or winding, which serves to increase interfacial contact and reduce a need and/or amount for compressive force/pressure to be applied in the battery.

In one embodiment, a lithium-ion electrochemical pouch cell has a 3.5 Ah capability. It has a first negative electrode comprising negative electroactive materials comprising about 10 wt. % LSO (specifically 9.45 wt. %) and 90 wt. % graphite (specifically 85.05 wt. %). More specifically, the graphite negative electroactive particles may have a D50 about 13 μm, a total surface area BET of 1.5 m²/g, and a tapped density of about 1 g/cm³, while the LSO particles have a D50 of about 8.3 μm, a total surface area BET of 1.3 m²/g, and a tapped density of about 1.3 g/cm³. The anode polymeric binder comprises about 1.7 wt. % of NaPAA, about 1.4 wt. % of CMC, and about 1.8 wt. % of SBR. The negative electroactive material further comprises conductive particles including single wall carbon nanotube (SWCNTs) at about at 0.1 wt. % Super P™ carbon black at about 0.5 wt. %. The negative active material layer of the negative electrode has a capacity loading of about 4.4 mAh/cm (for a single-sided coating, 0.1 C at room temperature or about 21° C.), a pressing density of about 1.6 g/cm³, and a porosity of about 34%.

The second positive electrode comprises NMCA/NCMA. More specifically, the NCMA has a formula of LiNi_{0.9}Co_{0.05}Mn_{0.03}Al_{0.02}O₂, including secondary particles blended with large diameter (D50 of about 13.5 μm) and small particles (D50 of about 3.6 μm). The overall blend has an average D50 particle diameter of about 11.3 μm, a BET surface area of about 0.55 m², and a tapping density of about 2.48 g/cm³. Overall, the positive electrode has NMCA at about 95 wt. % (e.g., 94.9 wt. of the electroactive material layer distributed in a polyvinylidene fluoride (PVDF) polymeric binder in N-methyl-2-pyrrolidone (NMP) solvent present at about 2 wt. %. The positive active material layer further comprises electrically conductive carbon-containing particles including a carbon black (such as, Super P™) at about 2.5 wt. %, a conductive graphite particle (commercially available as TIMCAL TIMREX® KS-6 Synthetic Graphite) at about 0.5 wt. %. The positive active material layer has a capacity loading of about 4 mAh/cm² (for a single-sided coating, 0.1 C at room temperature or about 21° C.), a pressing density of about 3.4 g/cm³, and a porosity of about 28%.

The separator in this example has a thickness of about 15 μm, a porosity of about 40%, and a PVDF coating with a thickness of about 1.5 μm on both sides of the separator. The non-aqueous liquid electrolyte comprises 1 M LiPF₆, EC/DMC solvents at a volume ratio of 3:7, FEC at 2 wt. %, VC 1 wt. %, TMSPi at 1 wt. %, LiBOB at 1 wt. %, and DTD at 1 wt. %. The electrode stack/structure may be formed either with or without hot lamination after stacking.

In another embodiment, a lithium-ion electrochemical pouch cell has a 3.7 Ah capability. A first negative electrode comprises negative electroactive materials comprising about 20 wt. % LSO (specifically 18.9 wt. %) and 80 wt. % graphite (specifically 75.6 wt. %). More specifically, the graphite negative electroactive particles may have a D50 about 13 μm, a total surface area BET of 1.5 m²/g, and a tapped density of about 1 g/cm³, while the LSO particles have a D50 of about 8.3 μm, a total surface area BET of 1.3 m²/g, and a tapped density of about 1.3 g/cm³. The anode polymeric binder comprises about 1.7 wt. % of NaPAA, about 1.4 wt. % of CMC, and about 1.8 wt. % of SBR. The negative electroactive material further comprises conductive particles including single wall carbon nanotube (SWCNTs) at about at 0.1 wt. % Super P™ carbon black at about 0.5 wt. %. The negative active material layer of the negative electrode has a capacity loading of about 4.4 mAh/cm² (for a single-sided coating, 0.1 C at room temperature or about 21° C.), a pressing density of about 1.6 g/cm³, and a porosity of about 34%.

The second positive electrode comprises NMCA/NCMA. More specifically, the NCMA has a formula of LiNi_{0.9}Co_{0.05}Mn_{0.03}Al_{0.02}O₂, including secondary particles blended with large diameter (D50 of about 13.5 μm) and small particles (D50 of about 3.6 μm). The overall blend has an average D50 particle diameter of about 11.3 μm, a BET surface area of about 0.55 m², and a tapping density of about 2.48 g/cm³. Overall, the positive electrode has NMCA at about 95 wt. % (e.g., 94.9 wt. %) of the electroactive material layer distributed in a polyvinylidene fluoride (PVDF) polymeric binder in N-methyl-2-pyrrolidone (NMP) solvent present at about 2 wt. %. The positive active material layer further comprises electrically conductive carbon-containing particles including a carbon black (such as, Super P™) at about 2.5 wt. %, a conductive graphite particle (commercially available as TIMCAL TIMREX® KS-6 Synthetic Graphite) at about 0.5 wt. %. The positive active material layer has a capacity loading of about 4 mAh/cm² (for a single-sided coating, 0.1 C at room temperature or about 21° C.), a pressing density of about 3.4 g/cm³, and a porosity of about 28%.

The separator in this example has a thickness of about 15 μm, a porosity of about 40%, and a PVDF coating with a thickness of about 1.5 μm on both sides of the separator. The non-aqueous liquid electrolyte comprises 1 M LiPF₆, EC/DMC solvents at a volume ratio of 3:7, FEC at 2 wt. %, VC 1 wt. %, TMSPi at 1 wt. %, LiBOB at 1 wt. %, and DTD at 1 wt. %. The electrode stack/structure may be formed either with or without hot lamination after stacking.

In yet another embodiment, a lithium-ion electrochemical pouch cell has a 2 Ah capability. A first negative electrode comprises negative electroactive materials comprising about 20 wt. % LSO (specifically 19.04 wt. %) and 80 wt. % graphite (specifically 76.16 wt. %). More specifically, the graphite negative electroactive particles may have a D50 about 13 μm, a total surface area BET of 1.5 m²/g, and a tapped density of about 1 g/cm³, while the LSO particles have a D50 of about 8.7 μm, a total surface area BET of 0.84 m²/g, and a tapped density of about 1.27 g/cm³. The anode polymeric binder comprises about 1.2 wt. % of CMC and about 3 wt. % of SBR. The negative electroactive material further comprises conductive particles including single wall carbon nanotube (SWCNTs) at about at 0.1 wt. % and Super P™ carbon black at about 0.5 wt. %. The negative active material layer of the negative electrode has a capacity loading of about 5.5 mAh/cm² (for a single-sided coating, 0.1 C at room temperature or about 21° C.), a pressing density of about 1.6 g/cm³, and a porosity of about 34%.

The second positive electrode comprises NMCA/NCMA. More specifically, the NCMA has a formula of LiNi_{0.9}Co_{0.05}Mn_{0.03}Al_{0.02}O₂, including secondary particles blended with large diameter (D50 of about 13.5 μm) and small particles (D50 of about 3.6 μm). The overall blend has an average D50 particle diameter of about 11.3 μm, a BET surface area of about 0.55 m², and a tapping density of about 2.48 g/cm³. Overall, the positive electrode has NMCA at about 95 wt. % (e.g., 94.6 wt. of the electroactive material layer distributed in a polyvinylidene fluoride (PVDF) polymeric binder in N-methyl-2-pyrrolidone (NMP) solvent present at about 2 wt. %. The positive active material layer further comprises electrically conductive carbon-containing particles including a carbon black (such as, Super P™) at about 2 wt. %, a conductive graphite particle (commercially available as TIMCAL TIMREX® KS-6 Synthetic Graphite) at about 1 wt. % and multiwalled carbon nanotubes (MWCNT) at about 0.4 wt. %. The positive active material layer has a capacity loading of about 5 mAh/cm² (for a single-sided coating, 0.1 C at room temperature or about 21° C.), a pressing density of about 3.4 g/cm³, and a porosity of about 28%.

The separator in this example has a thickness of about 20 μm, a porosity of about 45%, and has no ceramic coating. The non-aqueous liquid electrolyte comprises 1M LiPF₆, EC/DMC solvents at a volume ratio of 3:7, FEC at 2 wt. %, VC 1 wt. %, and TMSPi at 1 wt. %. The electrode stack/structure may be formed without hot lamination after stacking.

In a further embodiment, a lithium-ion electrochemical pouch cell has a 3.7 Ah capability. A first negative electrode comprises negative electroactive materials comprising about 30 wt. % LSO (specifically 28 wt. %) and 70 wt. % graphite (specifically 67.05 wt. %). More specifically, the graphite negative electroactive particles may have a D50 about 13 μm, a total surface area BET of 1.5 m²/g, and a tapped density of about 1 g/cm³, while the LSO particles have a D50 of about 8.3 μm, a total surface area BET of 1.3 m²/g, and a tapped density of about 1.3 g/cm³. The anode polymeric binder comprises about 1.7 wt. % of NaPAA, about 1.5 wt. % of CMC and about 1.3 wt. % of SBR. The negative electroactive material further comprises conductive particles including single wall carbon nanotube (SWCNTs) at about at 0.15 wt. %. The negative active material layer of the negative electrode has a capacity loading of about 5.5 mAh/cm² (for a single-sided coating, 0.1 C at room temperature or about 21° C.), a pressing density of about 1.6 g/cm³, and a porosity of about 34%.

The second positive electrode comprises NMCA/NCMA. More specifically, the NCMA has a formula of LiNi_{0.9}Co_{0.05}Mn_{0.03}Al_{0.02}O₂, including secondary particles blended with large diameter (D50 of about 13.5 μm) and small particles (D50 of about 3.6 μm). The overall blend has an average D50 particle diameter of about 11.3 μm, a BET surface area of about 0.55 m², and a tapping density of about 2.48 g/cm³. Overall, the positive electrode has NMCA at about 95 wt. % (e.g., 94.9 wt. %) of the electroactive material layer distributed in a polyvinylidene fluoride (PVDF) polymeric binder in N-methyl-2-pyrrolidone (NMP) solvent present at about 2 wt. %. The positive active material layer further comprises electrically conductive carbon-containing particles including a carbon black (such as, Super P™) at about 2 wt. %, a conductive graphite particle (commercially available as TIMCAL TIMREX® KS-6 Synthetic Graphite) at about 1 wt. % and single walled carbon nanotubes (SWCNT) at about 0.1 wt. %. The positive active material layer has a capacity loading of about 5 mAh/cm² (for a single-sided coating, 0.1 C at room temperature or about 21° C.), a pressing density of about 3.4 g/cm³, and a porosity of about 28%.

The separator in this example has a thickness of about 15 μm, a porosity of about 40%, and a PVDF coating with a thickness of about 1.5 μm on both sides of the separator. The non-aqueous liquid electrolyte comprises 1M LiPF₆, EC/DMC solvents at a volume ratio of 3:7, FEC at 2 wt. %, VC 1 wt. %, and TMSPi at 1 wt. %. The electrode stack/structure may be formed either with or without hot lamination after stacking.

### Example 1

A lithium-ion electrochemical pouch cell having an approximate 2 Ah cell capacity is formed. A negative electrode contains about 20 wt. % LSO (specifically 19.04 wt. %) and about 80 wt. % graphite (specifically 76.16 wt. %) based on a total amount of negative electroactive materials. The graphite negative electroactive particles may have a D50 about 13 μm, a total surface area BET of 1.5 m²/g, and a tapped density of about 1 g/cm³. The LSO particles have a D50 of about 8.7 μm, a total surface area BET of 0.84 m²/g, and a tapped density of about 1.27 g/cm³. The negative active material layer further comprises conductive particles including single wall carbon nanotube (SWCNTs) at about at 0.1 wt. % and Super P™ carbon black at about 0.5 wt. %. The particles are distributed in a polymeric matrix of about 1.2 wt. % of CMC and about 3 wt. % of SBR. The negative active material layer of the negative electrode has a capacity loading of about 5.5 mAh/cm² (for a single-sided coating, 0.1 C at room temperature or about 21° C.), a pressing density of about 1.6 g/cm³, and a porosity of about 34%.

Such a negative anode electrode may be formed by a slurry coating process that includes forming and mixing a slurry using aqueous binder SBR/CMC/NaPAA with an aqueous solvent by combining these materials with electroactive material particles and electrically conductive particles. The slurry may be cast on a copper current collector having a thickness of about 8 μm, which is then dried to form the negative electroactive material layer thereon.

A positive electrode comprises NMCA/NCMA (LiNi_{0.9}Co_{0.05}Mn_{0.03}Al_{0.02}O₂) including secondary particles blended with large diameter (D50 of about 13.5 μm) and small particles (D50 of about 3.6 μm). The overall blend has an average D50 particle diameter of about 11.3 μm, a BET surface area of about 0.55 m², and a tapping density of about 2.48 g/cm³. Overall, the positive electrode has NMCA at about 95 wt. % (e.g., 94.6 wt. %) of the electroactive material layer distributed in a polyvinylidene fluoride (PVDF) polymeric binder in N-methyl-2-pyrrolidone (NMP) solvent present at about 2 wt. %. The positive active material layer further comprises electrically conductive carbon-containing particles including a carbon black (such as, Super P™) at about 2 wt. %, a conductive graphite particle (commercially available as TIMCAL TIMREX® KS-6 Synthetic Graphite) at about 1 wt. % and multiwalled carbon nanotubes (MWCNT) at about 0.4 wt. % distributed in the polymeric binder. The positive active material layer has a capacity loading of about 5 mAh/cm² (for a single-sided coating, 0.1 C at room temperature or about 21° C.), a pressing density of about 3.4 g/cm³, and a porosity of about 28%.

Such a positive cathode electrode may be formed by a slurry coating process that includes forming and mixing a slurry using a PVDF binder in NMP solvent and combining this material with electroactive material particles and electrically conductive particles. The slurry may be cast on an aluminum current collector having a thickness of about 12 μm. The slurry is prepared in a double planetary mixer (DPM) based on a given formulation. After slurry preparation and parameters collection, the qualified slurry was coated through a slot-die coating machine to fabricate double-sided coated electrode at a capacity loading of 5 mAh/cm².

The separator in this example has a thickness of about 20 μm, a porosity of about 46%, and has no ceramic coating. The non-aqueous liquid electrolyte comprises 1 M LiPF₆, EC/DMC solvents at a volume ratio of 3:7, FEC at 2 wt. %, VC 1 wt. %, and TMSPi at 1 wt. %.

The electrode stack/structure is formed at room temperature without hot lamination after stacking. The NCMA positive electrodes and the LSO and graphite negative electrodes went through a stacked pouch cell assembling process, including stacking, welding, pre-sealing, drying, followed by filling with liquid electrolyte, formation, degassing, final sealing and sorting steps to make stacked bilayer pouch cells in a dry room with a dew point of −45° C. An energy density of the assembled cell is calculated using 100 Ah cell format to be about 330 Wh/kg.

### Example 2

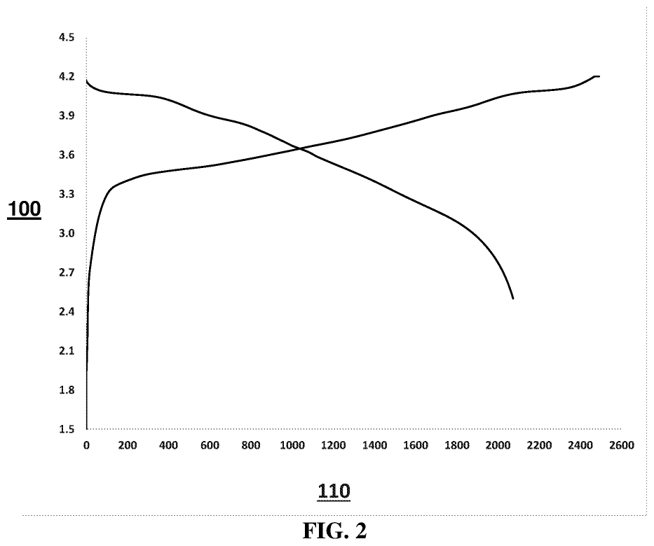

The assembled cell of Example 1 is tested for determining initial Coulombic Efficiency (C.E.) and initial discharge capacity. FIG. 2 shows voltage (y-axis labeled 100, in volts (V)) versus capacity (x-axis labeled 110, in mA/h) is tested for the cell. The first cycle is conducted at C/20 at about 25° C. More specifically, constant charge, constant voltage (CCCV) charge at C/20 with a C/50 taper is tested, with a constant charge (CC) discharge at C/20. A voltage range during testing is about 2.5V to about 4.2V. A compression pressure on the cell is about 25 psi. As shown in FIG. 2, an initial Coulombic efficiency (C. E.) of pouch cells is about 83.4% and an initial discharge capacity delivered is about 2.07 Ah.

### Example 3

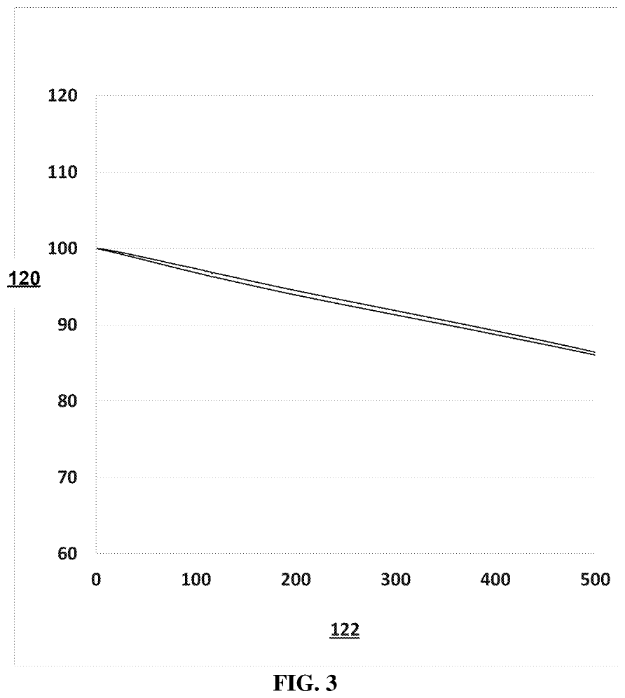

FIG. 3 shows capacity retention (y-axis labeled 120 (%)) versus charge-discharge cycle number (x-axis labeled 122) for testing of an example of the electrochemical battery pouch cell prepared in Example 1. CCCV charge is tested at 1 C with a C/20 taper, while CC discharge is at 1 C. A voltage range during testing is about 2.5V to about 4.2V. A compression pressure on the cell is about 25 psi. 1 C cycling performance is conducted at about 25° C. As shown in FIG. 3, after 500 charge-discharge cycles, the cell has capacity retention of 86%.

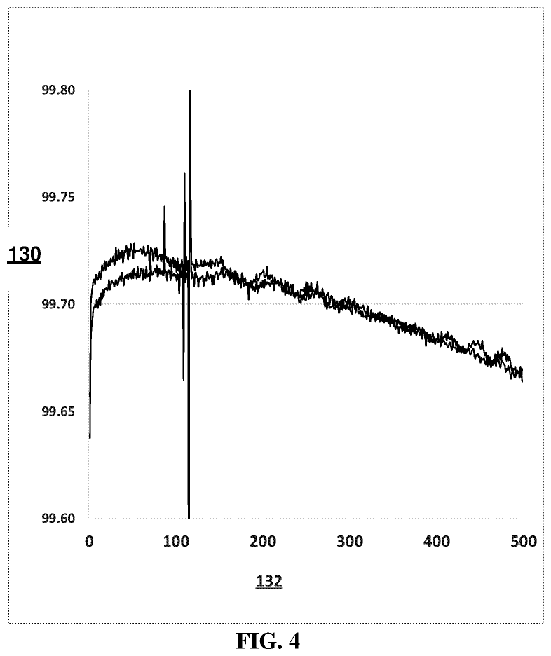

FIG. 4 shows a Coulombic Efficiency ((C. E.) y-axis labeled 130 (%)) versus charge-discharge cycle number (x-axis labeled 132) for the electrochemical battery pouch cell prepared in Example 1. 1 C cycling performance is conducted at about 25° C. An average C. E. is about 99.7% for the cell tested.

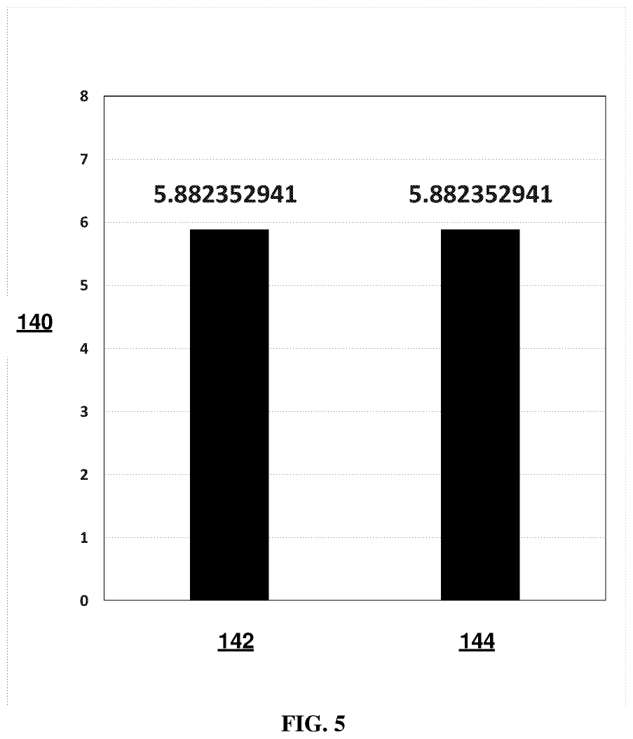

FIG. 5 shows a swelling ratio in the cycle life test. Y-axis is labeled 140 (%) showing the cell swelling ratio for the electrochemical battery pouch cell prepared in Example 1 prior to (x-axis label 142) and after (x-axis label 144) 500 charge-discharge cycles. As can be seen, the cell is stable and the swelling ratio before and after 500 cycles of operation remains 5.9%.

Thus, FIGS. 3-5 show that the electrochemical battery pouch cell prepared in Example 1 prepared in accordance with certain aspects of the present disclosure have outstanding discharge capacity retention, high C.E and low swelling ratio during the 1 C cycle life test.

### Example 4

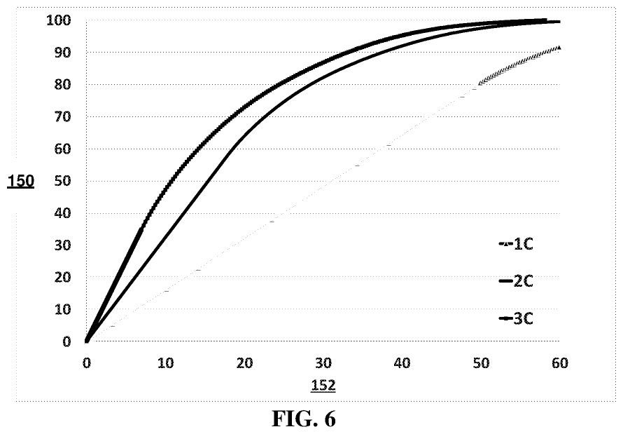

FIG. 6 shows state of charge (SOC) (y-axis labeled 150 (%)) versus time (x-axis labeled 152 (minutes)) for testing of an example of the electrochemical battery pouch cell prepared in Example 1. A charge rate is shown at about 25° C. SOC % is normalized to C/3 rate for CCCV capacity. 1 C, 2 C, and 3 C charge rates are shown. A voltage range during testing is about 2.5V to about 4.2V. A compression pressure on the cell is about 25 psi. As shown in FIG. 6, the cell charged to 73% SOC in 20 minutes demonstrating desirably fast charging capability. Further, an 80% SOC can be achieved within 30 minutes per additional testing.

In various aspects, the present disclosure provides high-energy density electrochemical cells or batteries that include negative electrodes comprising lithiated silicon oxide (LSO) that may be combined with carbonaceous negative electroactive materials, like graphite. For example, the negative electrode may comprise 9 to 30% LSO and a balance of graphite as the negative electroactive materials. The negative electrode may further comprise electrically conductive particles distributed in the polymeric binder forming the porous composite negative electrode. These negative electrodes may be paired with high-performance positive electrodes that comprise lithium nickel-rich manganese cobalt oxide electroactive materials to provide electrochemical cells that exhibit various advantages, including by way of non-limiting example, improved cell energy density, enhanced cyclability/capacity retention, fast charge capability, and the ability to design cells with low or no compressive force (applied) pressure during the cycle test, module assembling, and regular operation.

In certain variations, an energy density of the cell is greater than or equal to about 290 Wh/kg, optionally greater than or equal to about 300 Wh/kg, optionally greater than or equal to about 310 Wh/kg, optionally greater than or equal to about 320 Wh/kg, and in certain variations, optionally greater than or equal to about 330 Wh/kg.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A negative electrode for an electrochemical cell that cycles lithium ions, the negative electrode comprising:
a current collector; and
an electroactive material layer disposed on the current collector that comprises:
a lithiated silicon oxide (LSO) negative electroactive material at greater than or equal to about 10 weight % to less than or equal to about 30 weight % of a total weight of the electroactive material layer: and
a carbonaceous negative electroactive material.

2. The negative electrode of claim 1, wherein the lithiated silicon oxide (LSO) is represented by a formula Li_{y}SiOₓ, where 0<y<1 and 0<x<2.

3. The negative electrode of claim 1, wherein the carbonaceous electroactive material comprises graphite present at greater than or equal to about 70 weight % of a total weight of the electroactive material layer.

4. The negative electrode of claim 1, wherein the electroactive material layer further comprises an electrically conductive particle.

5. The negative electrode of claim 4, wherein the electrically conductive particle comprises carbon and is selected from the group consisting of: carbon black, graphene, carbon nanoplates, carbon nanotubes, and combinations thereof.

6. The negative electrode of claim 1, the electroactive material layer further comprises a polymeric binder selected from the group consisting of: polyvinylidene difluoride (PVDF), poly(vinylidene fluoride-co-hexafluoropropylene) (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymer (SEBS), polyethylene glycol (PEO), polyacrylic acid (PAA), lithium polyacrylate (LiPAA), sodium polyacrylate (NaPAA), copolymers, and combinations thereof.

7. The negative electrode of claim 1, wherein the electroactive material layer is a porous composite layer that comprises the lithiated silicon oxide (LSO) negative electroactive material and the carbonaceous negative electroactive material distributed in a matrix of a polymeric binder.

8. The negative electrode of claim 7, wherein the polymeric binder is selected from the group consisting of: styrene-butadiene rubber (SBR), sodium carboxymethyl cellulose (CMC), polyacrylic acid (PAA), lithium polyacrylate (LiPAA), sodium polyacrylate (NaPAA), copolymers, and combinations thereof.

9. The negative electrode of claim 1, wherein the electroactive material layer comprises a cumulative amount of the lithiated silicon oxide (LSO) and the carbonaceous negative electroactive material at greater than or equal to about at 90 weight % to less than or equal to about 98 weight % of a total weight of the electroactive material layer.

10. The negative electrode of claim 1, wherein the carbonaceous negative electroactive material comprises graphite and the electroactive material layer comprises:
a cumulative amount of the lithiated silicon oxide (LSO) and the graphite at greater than or equal to about at 90 weight % to less than or equal to about 98 weight % of a total weight of the electroactive material layer;
a polymeric binder at greater than or equal to about at 1 weight % to less than or equal to about 10 weight % of a total weight of the electroactive material layer; and
a plurality of electrically conductive particles comprising carbon including a single walled carbon nanotube (SWCNT) at greater than or equal to about at 0.05 weight % to less than or equal to about 1 weight % of a total weight of the electroactive material layer and a cumulative amount of other electrically conductive particles comprising carbon present at greater than or equal to about at 1 weight % to less than or equal to about 5 weight % of a total weight of the electroactive material layer.

11. The negative electrode of claim 1, wherein the electroactive material layer on one side of the current collector has a capacity loading of a total amount of negative electroactive materials at greater than or equal to about 3.3 mAh/cm for a 0.1 C rate at 21° C., the electroactive material has a press density of greater than or equal to about 1.4 g/cm³ and a porosity of greater than or equal to about 25%.

12. An electrochemical cell that cycles lithium ions, the electrochemical cell comprising:
a first electrode comprising a first current collector having a porous negative active material layer disposed thereon that comprises:
a lithiated silicon oxide (LSO) negative electroactive material at greater than or equal to about 10 weight % to less than or equal to about 30 weight % of a total weight of the porous negative active material layer: and
a carbonaceous negative electroactive material;
a second electrode comprising a porous positive active material layer comprising a positive lithium containing, nickel-rich electroactive material;
a porous separating layer disposed between the first electrode and the second electrode, and
an electrolyte disposed in pores of the separating layer.

13. The electrochemical cell of claim 12, wherein the positive lithium-containing, nickel-rich electroactive material comprises a lithium nickel manganese cobalt aluminum oxide represented by a formula of LiNiₓCo_{y}Mn_{z}Al_{(1-x-y-z)}O₂, where x is greater than or equal to about 0.8 and less than or equal to about 1, y is greater than 0 and less than or equal to about 0.2, and z is greater than 0 and less than or equal to about 0.2.

14. The electrochemical cell of claim 12, wherein the positive lithium-containing, nickel-rich electroactive material comprises a lithium nickel manganese cobalt aluminum oxide represented by a formula of LiNiₓCo_{y}Mn_{z}Al_{(1-x-y-z)}O₂ where 0.83≤x≤1, 0≤y≤0.17, and 0≤z≤0.17.

15. The electrochemical cell of claim 12, wherein the lithiated silicon oxide (LSO) is represented by a formula Li_{y}SiOₓ, where 0<y<1 and 0<x<2 and the carbonaceous electroactive material comprises graphite present at greater than or equal to about 70 weight % of a total weight of the electroactive material layer.

16. The electrochemical cell of claim 12, wherein the porous negative active material layer further comprises an electrically conductive particle comprising carbon selected from the group consisting of: carbon black, graphene, carbon nanoplates, carbon nanotubes, and combinations thereof and the porous positive active material layer further comprises an electrically conductive particle comprising carbon selected from the group consisting of: carbon black, graphite, graphene, carbon nanoplates, carbon nanotubes, and combinations thereof.

17. The electrochemical cell of claim 12, wherein the porous negative active material layer and the porous positive active material layer each further comprises a polymeric binder independently selected from the group consisting of: polyvinylidene difluoride (PVDF), poly(vinylidene fluoride-co-hexafluoropropylene) (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymer (SEBS), polyethylene glycol (PEO), polyacrylic acid (PAA), lithium polyacrylate (LiPAA), sodium polyacrylate (NaPAA), copolymers, and combinations thereof.

18. The electrochemical cell of claim 12, wherein the electrolyte comprises at least one lithium salt and at least one organic solvent, the at least one lithium salt selected from the group consisting of: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiFSI), lithium bis(trifluoromethanesulfonyl)imide (LiTFSI), and combinations thereof, and the at least one solvent selected from the group consisting of: cyclic carbonates, linear carbonates, aliphatic carboxylic esters, gamma (γ)-lactones, chain structure ethers, cyclic ethers, sulfur compounds, and combinations thereof.

19. The electrochemical cell of claim 12 having a capacity ratio of first electrode (N) to second (P) electrode (N/P ratio) of greater than or equal to about 1 to less than or equal to about 1.2.

20. An electrochemical cell that cycles lithium ions, the electrochemical cell comprising:
a first electrode comprising a first current collector having a porous negative active material layer disposed thereon that comprises a cumulative amount of negative electroactive materials at greater than or equal to about at 90 weight % to less than or equal to about 98 weight % of a total weight of the electroactive material layer, wherein the negative electroactive materials comprise:
a lithiated silicon oxide (LSO) negative electroactive material at greater than or equal to about 10 weight % to less than or equal to about 30 weight % of a total weight of the porous negative active material layer: and
graphite at greater than or equal to about 70 weight % to less than or equal to about 90 weight % of a total weight of the porous negative active material layer;
a second electrode comprising a porous positive active material layer comprising a lithium nickel manganese cobalt aluminum oxide represented by a formula of LiNiₓCo_{y}Mn_{z}Al_{(1-x-y-z)}O₂, where x is greater than or equal to about 0.8 and less than or equal to about 1, y is greater than 0 and less than or equal to about 0.2, and z is greater than 0 and less than or equal to about 0.2;
a porous separating layer disposed between the first electrode and the second electrode, and
an electrolyte disposed in pores of the separating layer, wherein the electrochemical cell has an energy density of greater than or equal to about 290 Wh/kg.
